(19) United States
(12) Patent Application Publication
(10) Pub. No.: US 2016/0320791 A1
(43) Pub. Date: Nov. 3, 2016

(54) Zero Droop Compliant Handle

(71) Applicant: Oceaneering International, Inc., Houston, TX (US)

(72) Inventors: William Claude Robertson, Houston, TX (US); Mark Charles Philip, Cypress, TX (US)

(73) Assignee: Oceaneering International, Inc., Houston, TX (US)

(21) Appl. No.: 15/142,191

(22) Filed: Apr. 29, 2016

Related U.S. Application Data
(60) Provisional application No. 62/155,326, filed on Apr. 30, 2015.

(51) Int. Cl. G05G 1/00

(52) U.S. Cl. CPC G05G 1/00

(57) ABSTRACT

A zero droop handle a housing comprises a coupling end and an interior void; a shaft comprising a first end and a second end where the first end is disposed at least partially within the housing proximate the coupling end of the housing and extends through a shaft coupler, disposed at least partially within the interior void and configured to allow movement of the shaft within the interior void, and first pressure and second pressure plates disposed about the shaft where the first pressure plate is movable about the shaft and the second pressure plate is secured at a predetermined position along the shaft. A spring is disposed intermediate the first and second pressure plates and configured to urge the first pressure plate against the coupling end of the housing. A cam plate, disposed within the interior void, is secured to the first end of the shaft to prevent the shaft coupler from further travel about the shaft and configured to allow movement of the first end of the shaft and the shaft coupler within the housing.

### RELATION TO PRIOR APPLICATIONS

This application claims the benefit of, and priority through, U.S. Provisional Application 62/155,326, titled “Zero Drop Compliant Handle,” filed Apr. 30, 2015.

### BACKGROUND

The disclosed zero droop compliant handle addresses various issues with a hot-stab T-handle. Current art T-handles are compliant and a section in the T-handle is typically a rubber overmold of a compliant member—usually a piece of wire rope or a U-joint—that allows the handle to bend and twist slightly. In use, this compliant section bend or droops slightly under the weight of the stab and this effect gets worse with time.

Advanced remotely operated vehicles (ROV) may automatically perform certain tasks such as inserting a hot-stab. In some ROVs vision systems and programmed kinematics allow an ROV operator to identify a receptacle for a computer, push a button, and allow the ROV to take over, tracking the receptacle and inserting the stab. However, the droop in the hot-stab can create problems with these new ROVs and compliance is needed in case of misalignment so the hot-stab does not bind in the receptacle.

### FIGURES

Various figures are included herein which illustrate aspects of embodiments of the disclosed invention.

FIG. 1 is a cut-away view in partial perspective of an exemplary handle;

FIG. 2 is a cut-away view in partial perspective of an exemplary handle; and

FIG. 3 is a cut-away view in partial perspective of an exemplary handle.

### DESCRIPTION OF EXEMPLARY EMBODIMENTS

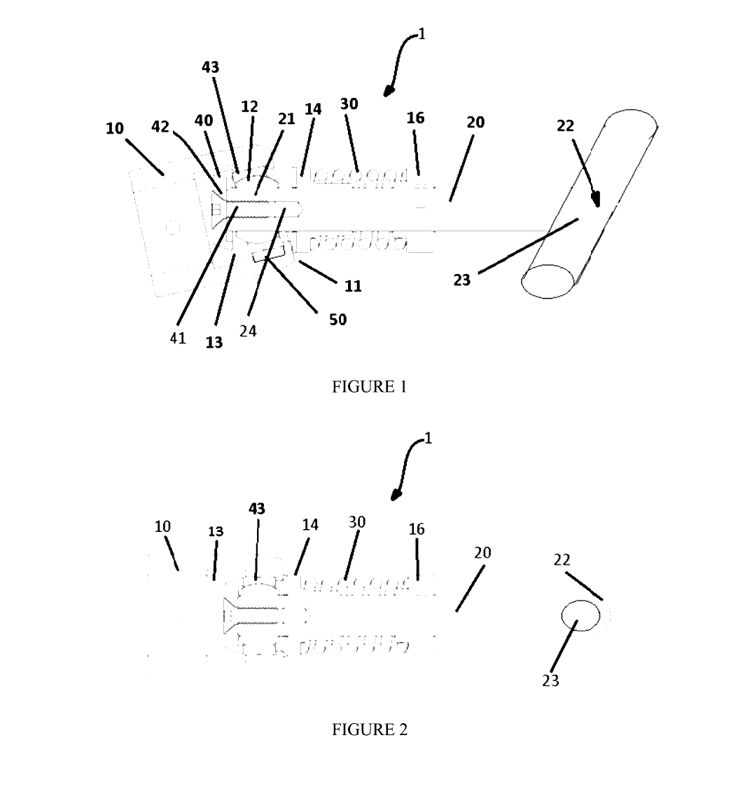

Referring to FIG. 1, zero droop compliant handle 1 comprises housing 10 which comprises coupling end 11; first pressure plate 14; second pressure plate 16; shaft coupler 12 disposed at least partially within housing 10; shaft 20 comprising first end 21 and second end 22, where first end 21 is disposed at least partially within housing 10 proximate coupling end 11 and extends through shaft coupler 12, first pressure plate 14, and second pressure plate 16; spring 30 disposed about shaft 20 intermediate first pressure plate 14 and second plate 16, where spring 30 is configured to urge first pressure plate 14 against coupling end 11; and cam plate 40 disposed within housing 10 and secured to first end 21 of shaft 20.

In all embodiments, housing 10 comprises interior 13 which is configured to accept shaft coupler 13 and allow a predetermined amount of motion within housing 10 of shaft coupler 12. Housing 10 itself may be tubular or any other appropriate shape.

Typically, second pressure plate 16 is a collar typically fixed in place at a predetermined position along shaft 20 and shaft coupler 12 is configured to allow movement of shaft 20 within housing 10.

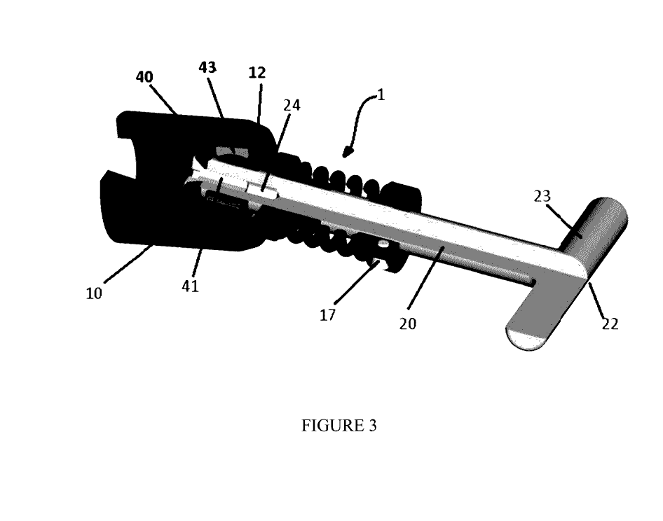

In certain embodiments shaft 20 comprises a thread (not shown in the figures) disposed intermediate first end 21 and second end 22 and second pressure plate 16 comprises a complementary thread (not shown in the figures) configured to engage the shaft thread and allow second pressure plate 16 to be adjustably secured to the shaft 20. In other contemplated embodiments, second pressure plate 16 is clamped around shaft 20 using one or more fasteners such as one or more pinch bolts 17 (FIG. 3).

Shaft coupler 12 typically comprises a spherical bearing such as a ball shaped bearing which allows both translation along shaft 21 and angular offset. In certain embodiments, shaft coupler 12 further comprises an outer coating which may be a rubber or plastic or the like or a combination thereof. Bearing race 43 may be disposed within housing 10 and shaft coupler 12 movingly disposed within bearing race 43.

In certain embodiments, one or both of first pressure plate 14 and second pressure plate 16 comprise flanged, circular plates. At least one of first pressure plate 14 and second pressure plate 16 is adjustable along shaft 20 to pre-load tension on the spring 30. In typical configurations first pressure plate 14 is movable about shaft 20 while second pressure plate 16 is secured to shaft 20.

Further, cam plate 40 is typically configured to secure shaft coupler 12 against first end 21 and to allow movement of first end 21 within housing 10 in response to pressure exerted by spring 30 against first pressure plate 14. Cam plate 40 may be rigidly secured to first end 21 of shaft 20 by any conventional means. In certain embodiments, first end 21 comprises threaded receiver 24, cam plate 40 comprises cam plate void 42, and fastener 41 is cooperatively and removably received through cam plate void 42 into threaded receiver 24 to rigidly secure cam plate 40 to first end 21.

Generally, second end 22 comprises handle 23, typically a remotely operated vehicle manipulate handle.

In contemplated embodiments, one or more sensors 50 may be disposed proximate shaft coupler 12, such as within or at least partially within housing 10. These sensors 50 are generally configured to provide feedback useful for control such as by an ROV (not shown in the figures) and may comprise a force feedback sensor, a deflection sensor, or the like, or a combination thereof. By way of example and not limitation, a deflection sensor may comprise a piezoelectric sensor or an electro-mechanical sensor or the like.

In the operation of exemplary embodiments, zero droop compliant handle 1, as described above, is connected to a further device such as a remotely operated vehicle compatible stab (not shown in the figures) and first pressure plate 14 and second pressure plate 16 used to hold spring 30 in place. Typically, second pressure plate 16 is adjusted and secured along shaft 20 to pre-load tension on spring 30 and spring 30 is then allowed to push first pressure plate 14 forward, i.e. towards housing 10, pulling a joint comprising shaft coupler 12, and, if present, bearing race 43, and eliminating droop in the stab. Typically, misaligned forces will then cause spring 30 to compress and shaft coupler 12 to break open in the misaligned direction, allowing compliance. Spring 30 may also be used to push housing 10 and shaft coupler 12 against cam plate 40 to result in a righting moment to prevent handle 1 from drooping.

If one or more sensors 50 are present, one or more of such sensors 50 may be used to provide real-time sensed data to a data receiver such as on an ROV (not shown in the figures) where the real-time sensed data may comprise feedback on predetermined parameters such as angle, deflection, force applied to handle 1, and the like, or a combination thereof. As used herein, a data receiver may comprise a remotely operated vehicle pilot or computer which is controlling insertion of equipment connected to handle 1.

The foregoing disclosure and description of the inventions are illustrative and explanatory. Various changes in the size, shape, and materials, as well as in the details of the illustrative construction and/or an illustrative method may be made without departing from the spirit of the invention.

1. A zero droop compliant handle, comprising:
a. a housing comprising a coupling end and an interior void;
b. a first pressure plate;
c. a second pressure plate;
d. a shaft coupler disposed at least partially within the interior void;
e. a shaft comprising a first end and a second end, the first end disposed at least partially within the housing proximate the coupling end of the housing and extending through the shaft coupler, the first pressure plate, and the second pressure plate, the first pressure plate movable about the shaft, the second pressure plate secured at a predetermined position along the shaft, the shaft coupler configured to allow movement of the shaft within the interior void;
f. a spring disposed intermediate the first pressure plate and the second plate, the spring configured to urge the first pressure plate against the coupling end of the housing; and
g. a cam plate disposed within the interior void and secured to the first end of the shaft to prevent the shaft coupler from further travel about the shaft, the cam plate configured to allow movement of the first end of the shaft and the shaft coupler within the housing.

2. The zero droop compliant handle of claim 1, wherein the first pressure plate and the second pressure plate comprise flanged, circular plates.

3. The zero droop compliant handle of claim 1, wherein the first pressure plate and the second pressure plate adjust tension on the spring.

4. The zero droop compliant handle of claim 1, wherein the shaft coupler comprises a spherical bearing which allows both translation along the shaft and angular offset.

5. The zero droop compliant handle of claim 1, wherein the shaft coupler further comprises an outer coating.

6. The zero droop compliant handle of claim 5, wherein the outer coating comprises a rubber or plastic.

7. The zero droop compliant handle of claim 1, further comprising a bearing race disposed at least partially within the housing and into which the shaft coupler is received.

8. The zero droop compliant handle of claim 1, wherein the second end comprises a handle.

9. The zero droop compliant handle of claim 1, further comprising a sensor disposed proximate the shaft coupler and configured to provide feedback useful for control of the zero droop compliant handle.

10. The zero droop compliant handle of claim 9, wherein the sensor comprises at least one of a force feedback sensor or a deflection sensor

11. The zero droop compliant handle of claim 10, wherein the deflection sensor comprises at least one of a piezoelectric sensor or an electro-mechanical sensor.

12. The zero droop compliant handle of claim 1, wherein the cam plate is rigidly secured to the first end of the shaft.

13. The zero droop compliant handle of claim 1, wherein:
a. the first end of fastener further comprises a threaded receiver;
b. the cam plate comprises cam plate void; and
c. the zero droop compliant handle further comprises fastener configured to be cooperatively and removably received through the cam plate void into the threaded receiver.

14. The zero droop compliant handle of claim 1, wherein:
a. the shaft comprises a thread disposed intermediate the first end and the second end; and
b. the second pressure plate comprises a complementary thread configured to engage the shaft thread and adjustably secure the second pressure plate to the shaft.

15. The zero droop compliant handle of claim 1, wherein the second pressure plate is clamped around the shaft using a pinch bolt.

16. A method, comprising:
a. connecting a zero droop compliant handle to a stab, the zero droop compliant handle comprising:
i. a housing comprising a coupling end and an interior void;
ii. a first pressure plate;
iii. a second pressure plate;
iv. a shaft coupler disposed at least partially within the interior void;
v. a shaft comprising a first end and a second end, the first end disposed at least partially within the housing proximate the coupling end of the housing and extending through the shaft coupler, the first pressure plate, and the second pressure plate, the first pressure plate movable about the shaft, the second pressure plate secured at a predetermined position along the shaft, the shaft coupler configured to allow movement of the shaft within the interior void;
vi. a spring disposed intermediate the first pressure plate and the second plate, the spring configured to urge the first pressure plate against the coupling end of the housing; and
vii. a cam plate disposed within the interior void and secured to the first end of the shaft to prevent the shaft coupler from further travel about the shaft, the cam plate configured to allow movement of the first end of the shaft and the shaft coupler within the housing
b. using the first pressure plate and the second pressure plate to hold the spring in place;
c. adjusting the second pressure plate to achieve a predetermined spring tension;
d. allowing the spring to push the first pressure plate forward, pulling the joint tight, and eliminating droop in the stab; and
e. allowing a misaligned force to cause the spring to compress and the joint to break open in the misaligned direction, allowing compliance.

17. The method of claim 16, further comprising:
a. equipping the zero droop compliant handle with a sensor positioned to provide feedback useful for control; and
b. using the sensor to provide real-time sensed data to a data receiver.

18. The method of claim 17, wherein the real-time sensed data comprises feedback on predetermined parameters comprises at least one of angle, deflection, and force applied to the handle.

19. The method of claim 17, wherein the data receiver comprises a pilot or computer which is controlling the insertion of the equipment connected to the handle.

20. The method of claim 17, further comprising using the spring pushing the housing and shaft coupler against the cam plate to result in a righting moment to prevent the handle from drooping.
